(19) United States
(12) Patent Application Publication
(10) Pub. No.: US 2026/0356197 A1
(43) Pub. Date: Nov. 12, 2026

(54) METHOD FOR PROVIDING INFORMATION FOR A MOTOR VEHICLE ABOUT WHETHER DRIVING ON A HARD SHOULDER IS PERMITTED AND/OR FORBIDDEN

(71) Applicant: Valeo Schalter und Sensoren GmbH, Bietigheim-Bissingen (DE)

(72) Inventor: Chen Ding, Bietigheim-Bissingen (DE)

(73) Assignee: Valeo Schalter und Sensoren GmbH, Bietigheim-Bissingen (DE)

(21) Appl. No.: 19/139,127

(22) PCT Filed: Dec. 12, 2023
(86) PCT No.: PCT/EP2023/085249

§ 371 Date: Jun. 13, 2025

(30) Foreign Application Priority Data
Dec. 15, 2022 (DE) 10 2022 133 415.5

(51) Int. Cl. B60K 35/28; G06V 20/58

(52) U.S. Cl. CPC B60K 35/28; G06V 20/582; B60K 2360/178

(57) ABSTRACT

Described is a method for providing information for a motor vehicle about whether driving on a hard shoulder is permitted or forbidden. The method includes providing sensor information describing surroundings of the motor vehicle and determining hard shoulder information describing whether a road on which the motor vehicle is traveling has a hard shoulder. When the road has the hard shoulder, the method includes determining road sign information describing a road sign that describes that the hard shoulder is temporarily open or that driving on the hard shoulder is forbidden. Additionally, the method includes checking whether the hard shoulder is permitted as a driving lane. If permitted, a notification message describing that driving on the hard shoulder is permitted is provided. If not permitted, a warning message describing that driving on the hard shoulder is forbidden is provided.

The invention relates to a method for providing information for a motor vehicle about whether driving on a hard shoulder is permitted and/or forbidden. The invention also relates to a motor vehicle, a control device for a motor vehicle and a computer program product for carrying out a method of this kind.

A road, in particular an expressway, can have at least one hard shoulder or breakdown lane. Driving on the hard shoulder is typically forbidden. In many countries, there is even a penalty, such as for example a fine, for driving on the hard shoulder. It can therefore be disadvantageous for a driver of a motor vehicle to drive on a hard shoulder. The driver should therefore be informed, if necessary, about whether driving on the hard shoulder is forbidden.

It can also be provided that the hard shoulder may be permitted, at least temporarily, as an additional traffic lane of the road. This can be useful, for example, during a period of heavy traffic, such as for example rush hour. In such a situation, however, it may be necessary to inform the driver of the motor vehicle of the possibility of driving on the hard shoulder, as otherwise they may assume, for example, that driving on the hard shoulder is forbidden.

DE 10 2020 215 778 A1 shows a method for planning an at least partially automated driving process by means of a driver assistance system of a vehicle. In this case, a plurality of trajectories are determined and verified independently of one another for a future driving process, with all trajectories that successfully pass the verification being entered in a driving trajectory list. The driving process then takes place based on a selected trajectory from the driving trajectory list.

DE 10 2015 201 266 A1 shows a method for operating a longitudinal control device of a motor vehicle that is drivable in an automated manner. A situation of the motor vehicle is recorded and, in the event that the motor vehicle leaves a road and is in a region that is not intended as a regular road, a signal is output to other road users.

WO 2021/148178 A1 shows a method for operating automated lane guidance of a motor vehicle. This is done taking into account image data, which is determined by means of a first sensor system. Sensor data is determined by means of a second sensor system in order to evaluate an execution of the automated lane guidance. The determined sensor data is used to assess whether the lane guidance is being executed correctly.

WO 2017/125184 A1 describes a method for providing lane change assistance information for a driver of a vehicle. If another vehicle, which is approaching the vehicle of the driver, is detected, it is verified whether it is possible and permissible for the vehicle to change to another lane on the same road. The driver of the vehicle is then informed in order to trigger a manual or automatic lane change of the vehicle.

It is the object of the invention to provide a solution by means of which a warning can be reliably given when driving on a hard shoulder is not allowed and/or an indication can be provided when driving on a hard shoulder is allowed.

The object is achieved by the subjects of the independent claims.

A first aspect of the invention relates to a method for providing information for a motor vehicle about whether driving on a hard shoulder is permitted and/or forbidden. The method can be used to provide information to a driver and/or another occupant of the motor vehicle about whether driving on the hard shoulder is permitted or forbidden for the motor vehicle. It can be provided that the method only provides information about whether driving on a hard shoulder is permitted or forbidden. Information is provided here by providing a message, such as for example a notification message in the case of driving on a hard shoulder being permitted and/or a warning message in the case of driving on a hard shoulder being forbidden. The hard shoulder is assigned to a road on which the vehicle is currently traveling. The hard shoulder can alternatively be referred to as the breakdown lane.

The method comprises providing sensor information that describes an environment of the motor vehicle. The sensor information describes, for example, a static and/or moving image of the environment of the motor vehicle. The sensor information preferably describes at least the part of the environment that adjoins a front region of the motor vehicle. The sensor information describes at least a part of the road on which the motor vehicle is traveling. The sensor information is provided, for example, to a control device of the motor vehicle or is provided by the control device.

The method comprises determining hard shoulder information by applying a hard shoulder detection criterion to the provided sensor information. The hard shoulder information describes whether the road on which the motor vehicle is traveling has a hard shoulder.

The hard shoulder detection criterion is an algorithm and/or a rule that can be used to establish whether or not the road on which the vehicle is traveling has a hard shoulder, for example based on image analysis or image processing methods. The hard shoulder can be detected as a hard shoulder on the basis of a road marking, for example. In this respect, known methods for determining an edge of a road, or a road marking which identifies a hard shoulder as such, can be used, for example.

If, according to the hard shoulder information, the road has the hard shoulder, traffic sign information is determined by applying a traffic sign detection criterion to the provided sensor information. The traffic sign information describes a traffic sign which divulges that the hard shoulder is at least temporarily permitted as a traffic lane, or that traveling on the hard shoulder is forbidden. The traffic sign comprises, for example, a text indicating that driving on the hard shoulder is allowed or forbidden. If a traffic sign which indicates that the hard shoulder is at least temporarily permitted as a traffic lane is not detected or determined, it can always be assumed, for example, that traveling on the hard shoulder is forbidden. The traffic sign detection criterion is an algorithm and/or a rule that is used to evaluate the sensor information in such manner that at least one traffic sign, preferably a road sign, is identified as such and its content is evaluated. In this case, the traffic sign detection criterion specifically searches for traffic signs that deal with traveling on the hard shoulder being permitted or forbidden.

The traffic sign information is preferably determined only after it has been established that the hard shoulder information divulges that the road has a hard shoulder. However, if it is established that there is no hard shoulder at all, the method can be terminated and, in particular, determination of the traffic sign information can be omitted.

The method comprises verifying whether the hard shoulder is permitted as a traffic lane according to the determined traffic sign information. If this is the case, a notification message is provided which at least divulges that driving on the hard shoulder is permitted. If it is therefore established that the determined traffic sign information divulges that the hard shoulder is available as a possible traffic lane, this can be communicated to the driver of the motor vehicle, for example, by outputting the provided notification message. The provided notification message can, for example, be output in the motor vehicle and/or used within the vehicle, for example by a driver assistance system and/or another vehicle function of the motor vehicle.

If it is established, during the verification, that traveling on the hard shoulder is forbidden according to the determined traffic sign information, a warning message is provided which at least divulges that traveling on the hard shoulder is forbidden. If it is therefore established that the determined traffic sign information divulges that the hard shoulder is not available as a possible traffic lane, this can be communicated to the driver of the motor vehicle, for example, by outputting the provided warning message. The provided warning message can, for example, be output in the motor vehicle and/or used within the vehicle, for example by a driver assistance system and/or another vehicle function of the motor vehicle.

It can be provided that the notification message and the warning message are provided alternatively or in addition to each other. It may therefore be the case that only the notification message is provided, but it is not verified at all whether traveling on the hard shoulder is forbidden according to the traffic sign information, and therefore it is not verified whether the warning message should be provided. This applies analogously to the reverse case, i.e. it is only possible to verify whether the warning message should be provided, but not whether the notification message should be provided. Alternatively or additionally, it can be provided that an information message is provided which corresponds to the content of the notification message and/or the warning message.

As a result of the notification message and/or the warning message being provided, the motor vehicle, in particular the driver and/or another occupant of the motor vehicle, is informed about whether driving on the hard shoulder is currently allowed or prohibited. It is therefore possible for the driver to always be informed about whether or not they should drive on the hard shoulder. According to the invention, therefore, a warning is reliably given when driving on a hard shoulder is not allowed and/or a notification is reliably provided when driving on the hard shoulder is allowed.

According to an exemplary embodiment, it is provided that if the road has the hard shoulder according to the hard shoulder information, traffic lane information is determined. The traffic lane information describes a traffic lane of the road on which the motor vehicle is traveling. It can be provided that the traffic lane information is determined by applying a traffic lane detection criterion to the sensor information. The traffic lane detection criterion is an algorithm and/or a rule that is used to evaluate at least the sensor information describing the environment in order to establish whether the motor vehicle is in a regular traffic lane or on a hard shoulder of the road. Alternatively or additionally, the traffic lane information can be determined by evaluating position information provided, for example, by a position determination device of the motor vehicle. The position determination can, for example, be based on data from a global navigation satellite system (GNSS). Alternatively or additionally, the traffic lane information can be provided by locating the motor vehicle on a map that is stored in the motor vehicle and/or that is provided to the motor vehicle by an external computing device.

It is verified whether the traffic lane corresponds to the hard shoulder of the road according to the traffic lane information. Only if this is not the case, i.e. only if the traffic lane described by the traffic lane information is not the hard shoulder of the road, is the notification message provided. If, therefore, the motor vehicle is already located on the hard shoulder, it is no longer indicated that the hard shoulder is permitted for use. This is independent of whether or not it was previously established that there is a traffic sign divulging that driving on the hard shoulder is allowed. This prevents information from being provided unnecessarily about whether the hard shoulder is permitted as an additional traffic lane after the driver of the motor vehicle has already driven onto the hard shoulder independently, for example.

A further exemplary embodiment provides that if the road has the hard shoulder according to the hard shoulder information, traffic lane information is determined which describes a traffic lane of the road on which the motor vehicle is traveling. The traffic lane information can be determined in the same way as described above. It is then verified whether the traffic lane corresponds to the hard shoulder of the road according to the traffic lane information. If this is the case, i.e. if the motor vehicle is located on the hard shoulder, the warning message is provided independently of the traffic sign information. It is therefore provided that whenever the motor vehicle is traveling on the hard shoulder, the driver of the motor vehicle can be informed, for example as a result of output of the provided warning message, that it is actually forbidden for a motor vehicle to travel on the part of the road on which it is currently located. The warning message is provided independently of a traffic sign and therefore in a generalized manner when driving on the hard shoulder. The warning message can, for example, at least include the fact that the motor vehicle is currently traveling on the hard shoulder and that driving on the hard shoulder is generally forbidden. The warning message can therefore indicate that it has been provided independently of the traffic sign information. This ensures that it is always easy to remember, when driving on the hard shoulder, that driving in such a way is generally not allowed.

Another exemplary embodiment provides for the provided warning message to be provided to the motor vehicle only if, according to the determined traffic sign information, traveling on the hard shoulder is forbidden and also, according to the determined traffic lane information, the traffic lane corresponds to the hard shoulder of the road. As an alternative to providing the warning message independently of the traffic sign information, it can therefore be provided that the warning message is output only if the corresponding traffic sign information has actually been determined. Nevertheless, the warning message is provided only if the motor vehicle is already traveling on the hard shoulder. This prevents the driver from being informed unnecessarily about driving on the hard shoulder being forbidden if the driver is not planning to drive onto the hard shoulder at all and/or shows no signs of doing so.

According to an additional exemplary embodiment, it is provided that if the motor vehicle is currently changing traffic lanes to the hard shoulder according to the traffic lane information, the warning message is provided only when the motor vehicle is traveling completely on the hard shoulder. This approach is based on the knowledge that it may be the case that a driver assistance system, such as for example a lane departure warning system, is already activated in the motor vehicle. Said lane departure warning system may be designed to keep the motor vehicle in the traffic lane it is currently driving in at least semi-automatically, in particular fully automatically. It is now possible for the driver assistance system to intervene first when the traffic lane is left, before the warning message is provided. For example, the driver assistance system can also output a warning message and/or actively prevent the traffic lane from being left, for example by intervening appropriately in the steering. The warning message can be provided, in accordance with the method according to the invention, only after the change of traffic lane has been completed, for example when the driver assistance system has been paused or deactivated. In this case, for example, the driver is first informed or warned by the driver assistance system that they have left the current traffic lane, and only after the motor vehicle is traveling completely on the hard shoulder can the driver be informed and warned, by means of the provided warning message, about driving on the hard shoulder being forbidden. This prevents, for example, the method for providing information about whether driving on the hard shoulder is permitted and/or forbidden from being activated unnecessarily if, for example, only a part of the motor vehicle only partially swerves onto the hard shoulder.

A preferred exemplary embodiment provides that the traffic lane information is determined and verified if the hard shoulder is permitted as a traffic lane according to the determined traffic sign information. It can in particular be provided that the traffic lane information is determined and verified only if the hard shoulder is permitted as a traffic lane according to the determined traffic sign information. As soon as it is established that the traffic lane corresponds to the hard shoulder of the road according to the traffic lane information, the traffic sign information is continuously determined and verified again. As soon as it is established, during this verification, that traveling on the hard shoulder is forbidden according to the newly determined traffic sign information, the warning message is provided. Therefore, while the vehicle is traveling on the hard shoulder on which driving is permitted, it is verified whether the permission, in particular the at least temporary permission, for the vehicle to drive on hard shoulder is still valid. If it is established, for example by detecting a traffic sign divulging that driving on the hard shoulder is forbidden, that driving on the hard shoulder is no longer allowed now or in the future, the warning message is provided.

However, if, while traveling on the hard shoulder, the determined traffic sign information continues to divulge that driving on the hard shoulder is permissible, any warning message is suppressed, i.e. no warning message is provided. It is therefore continuously monitored whether the motor vehicle can remain on the hard shoulder, which can be particularly convenient for the driver, as they do not have to actively concern themselves with keeping an eye on where they have to leave the hard shoulder again.

Furthermore, an exemplary embodiment provides that the hard shoulder detection criterion takes into account a color and/or a line type of a road marking of the road. Depending on the country, for example, the hard shoulder may be recognizable on the basis of a certain color of the road marking, for example on the basis of an orange road marking. The line type of the road marking can, for example, identify the hard shoulder as such. This can be the case, for example, if a solid line is arranged next to one or a plurality of traffic lanes, next to which line another solid line is arranged, with a distance between the two solid lines being large enough so that the region of the road there can represent a hard shoulder that can be used as a traffic lane when permitted.

Alternatively or additionally, the hard shoulder detection criterion can take into account a surface finish of the road. It may be the case that the hard shoulder has a different road finish, for example with a rough surface, than adjoining traffic lanes, which, for example, have a smoother surface compared to the hard shoulder. The surface finish can alternatively be referred to as surface topography and/or surface texture.

Alternatively or additionally, the hard shoulder detection criterion can comprise road edge detection methods. These methods are often referred to as road edge detection means. For example, a change from a typical surface finish of a road to a typical surface of vegetation adjoining the road can be detected, i.e., for example, the change from asphalt or concrete on the one hand to grass, forest and/or sand on the other. Known methods for road edge detection can be used here.

Various criteria and indicators can therefore be used to reliably and accurately detect the hard shoulder.

In an additional exemplary embodiment, it is provided to verify whether the road has a hard shoulder for one direction of travel on each of the two sides of at least one traffic lane. If this is the case, the traffic sign information is determined and verified for each of the two hard shoulders. It may therefore be the case that a road has a hard shoulder, for example for right-hand traffic, not only at a right-hand edge of the traffic lanes of a common direction of travel, but also at the opposite, left-hand edge of these traffic lanes. Similarly, with left-hand traffic, there may be hard shoulders on both sides of the traffic lanes of the common direction of travel. If the traffic lanes of both directions of travel on the road are considered, there are therefore up to four hard shoulders in total, on both sides for the respective direction of travel. If this is the case, all these hard shoulders are taken into account by the method, for example by providing the notification message and/or warning message for each hard shoulder. However, only the hard shoulders for which travel is allowed in the direction of travel in which the motor vehicle is traveling on the road are taken into account.

In an additional exemplary embodiment, it is provided that the provided notification message and/or warning message is output in the motor vehicle by means of an audible and/or visual output device. The corresponding message can therefore be output in the motor vehicle for example as a voice output by means of a loudspeaker device comprising at least one loudspeaker. Alternatively or additionally, it can, for example, be displayed as a text message, symbol and/or light signal by means of a display device. The display device is, for example, a screen, in particular a touch-sensitive screen, a head-up display and/or a light-emitting device in the motor vehicle. The output device can alternatively or additionally be encompassed by a mobile terminal positioned in the motor vehicle. The mobile terminal is, for example, a smartphone and/or tablet. The driver can therefore be provided with information by the output notification message and/or warning message reliably and, in the case of the audible output, also without being distracted from the driving situation.

According to a further exemplary embodiment, it is provided that the output is provided only once the motor vehicle has driven past the traffic sign which divulges that the hard shoulder is at least temporarily permitted as a traffic lane or that traveling on the hard shoulder is forbidden. It can therefore be provided that the notification message and/or warning message is provided immediately within the vehicle, for example by means of the control device of the motor vehicle. However, the procedure then waits until, for example, the region of the road to which the traffic sign applies actually begins by waiting until the motor vehicle has driven past the traffic sign before the audible and/or visual output is actually carried out by means of the output device. This prevents the driver from being informed too early about driving on the hard shoulder soon being allowed, for example, and, for example, from driving onto the hard shoulder immediately and thus at a point before the hard shoulder is permitted as a traffic lane.

Alternatively, it is possible to always output the notification message and/or warning message in the motor vehicle immediately after it/they has/have been provided.

Furthermore, an exemplary embodiment provides that the provided sensor information is recorded by means of a camera device of the motor vehicle. The camera device is, for example, a front camera, a side camera and/or a rear camera of the motor vehicle. Preferably, data from a front camera is used, which camera is arranged, for example, in a region of a windshield of the motor vehicle that is arranged at the top in the vertical direction of the motor vehicle. The sensor information recorded by means of the camera device is then transmitted, for example, to the control device of the motor vehicle and then provided by said control device. The motor vehicle itself therefore preferably determines the sensor information based on which the hard shoulder information and the traffic sign information is determined.

Alternatively or additionally, it is possible that the motor vehicle receives the sensor information, the hard shoulder information and/or the traffic sign information from an external computing device, for example a server, a backend and/or a cloud. For this purpose, a communication connection, which is in wireless form, can be provided between the motor vehicle and the external computing device. The communication connection can be provided via a wireless local area network (WLAN), a Bluetooth connection and/or a mobile data network, for example based on the Long Term Evolution (LTE), Long Term Evolution Advanced (LTE-A), Fifth Generation (5G) or Sixth Generation (6G) mobile radio standard.

Furthermore, in an exemplary embodiment, it can be provided that at least one variable traffic sign assigned to the road is taken into account as a traffic sign when applying the traffic sign detection criterion. A variable traffic sign is a traffic sign that can be displayed, changed and/or canceled if necessary. Alternatively, it can be referred to as a dynamic traffic sign. The variable traffic sign can be light-emitting and, for example, have at least one light-emitting diode for that purpose and/or can be in the form of a prismatic sign. This makes it clear how driving on the hard shoulder can be at least temporarily allowed and/or forbidden, as dynamically activatable traffic signs and therefore variable traffic signs are used. The traffic sign detection criterion can, for example, be specifically configured to detect variable traffic signs and evaluate their content.

A further aspect of the invention relates to a motor vehicle for carrying out the method described. The motor vehicle is thus designed to carry out the method described above. The motor vehicle is, for example, a passenger car, a truck, a bus, a motorcycle and/or a moped. The motor vehicle can have a control device.

A further aspect of the invention relates to a control device for a motor vehicle, which is designed to carry out the method described above. The control device carries out the described method, in particular an exemplary embodiment or a combination of exemplary embodiments of the described method. The control device has a processor device. The processor device can comprise at least one microprocessor and/or at least one microcontroller and/or at least one FPGA (field-programmable gate array) and/or at least one DSP (digital signal processor). Furthermore, the processor device can have program code, which can alternatively be referred to as a computer program product. The program code may be stored in a data memory of the processor device.

A further aspect of the invention relates to a computer program product. The computer program product is a computer program. The computer program product comprises instructions which, when the program is executed by a computer, such as for example by the control devices of the motor vehicle, cause the computer to carry out the steps of the method according to the invention.

The exemplary embodiments described in connection with the method according to the invention, both individually and in combination with each other, apply accordingly, insofar as applicable, to the motor vehicle according to the invention, the control device according to the invention and the computer program product according to the invention. The invention comprises combinations of the described exemplary embodiments, for which:

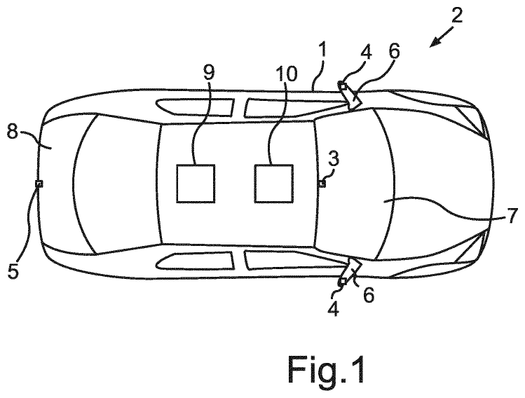

FIG. 1 shows a schematic representation of a motor vehicle with a plurality of cameras;

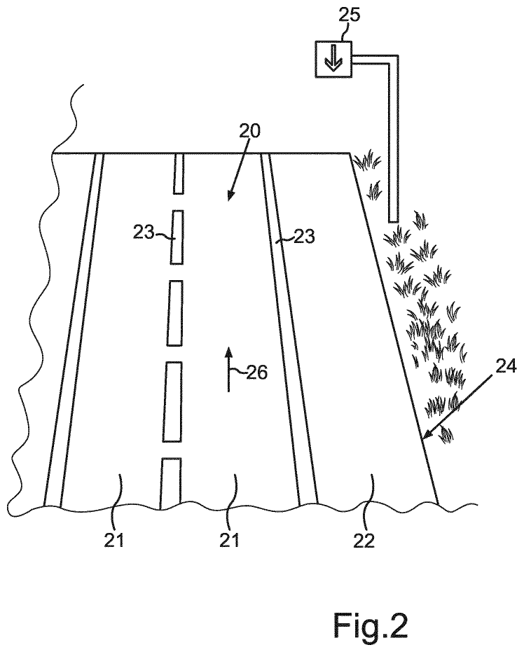

FIG. 2 shows a schematic representation of a road with a hard shoulder; and

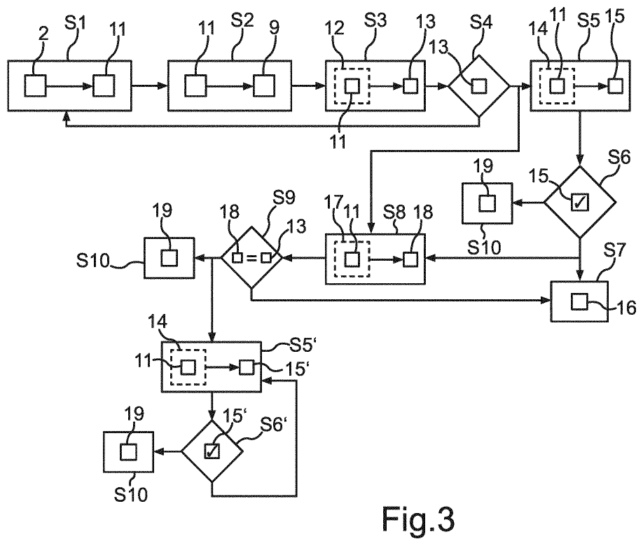

FIG. 3 shows, in schematic representation, a signal flow graph of a method for providing information for a motor vehicle about whether driving on a hard shoulder is permitted and/or forbidden.

FIG. 1 shows a motor vehicle 1 comprising a camera device 2. The camera device 2 here comprises, for example, a front camera 3, at least one side camera 4 and/or a rear camera 5. The camera device 2 preferably has at least the front camera 3. The side cameras 4 here are arranged in respective side mirrors 6 of the motor vehicle 1. The front camera 3 is arranged in a region of a windshield 7 of the motor vehicle 1 that is arranged at the top in a vertical direction of the motor vehicle 1. The rear camera 5 is arranged in a rear region 8 of the motor vehicle 1.

The motor vehicle 1 has a control device 9, which can alternatively be referred to as a computing device. Furthermore, the motor vehicle 1 can have an output device 10. This can be in the form of a display device, i.e. for example in the form of a screen, in particular in the form of a touch-sensitive screen and/or head-up display in the motor vehicle 1. Alternatively or additionally, it can be designed for audible output, i.e. can comprise a loudspeaker device which has at least one loudspeaker. Alternatively or additionally, the output device 10 can be encompassed by a mobile terminal positioned in the motor vehicle 1.

FIG. 2 shows a typical environment for which the method according to the invention is intended. The environment comprises a road 20 which has two traffic lanes 21. In addition, the road 20 has a hard shoulder 22. An arrow is used to outline a direction of travel 26, which applies to all the outlined traffic lanes 21 here. The individual traffic lanes 21 are marked by means of road markings 23, which are applied to the surface of the road 20. A dashed line as a road marking 23 is provided for this purpose between the individual traffic lanes 21, whereas a solid line as a road marking 23 separates the outer traffic lane 21 from the hard shoulder 22. To the side of the hard shoulder 22 here there is a road edge 24 on which grass grows, for example.

Typically, traveling on the hard shoulder 22 is forbidden. However, it can be provided that a traffic sign 25 is used to indicate at least temporarily that traveling on the hard shoulder 22 is allowed. The traffic sign 25 is outlined here purely by way of example as a variable traffic sign, which is in light-emitting form, for example, and here displays an arrow indicating that driving on the hard shoulder 22 is at least currently permitted. Traveling on the hard shoulder 22 is therefore allowed here. If driving on the hard shoulder 22 is currently forbidden, a cross can be displayed on the traffic sign 25, for example. The traffic sign 25 can alternatively or additionally be in the form of a mechanical variable traffic sign, for example in the form of a prismatic sign. Alternatively or additionally, a non-dynamic and therefore static traffic sign 25 is possible.

It can be provided that a further hard shoulder 22 is arranged on the opposite side of the traffic lanes 21 in relation to the hard shoulder 22. The road 20 can therefore have a hard shoulder 22 for the direction of travel 26 on each of the two sides of the traffic lanes 21. However, this is not shown here.

FIG. 3 shows method steps of a method for providing information for the motor vehicle 1 about whether driving on the hard shoulder 22 is permitted and/or forbidden. In a method step S1, sensor information 11 is recorded by means of the camera device 2, in particular at least by means of the front camera 3. The sensor information 11 describes an environment of the motor vehicle 1. It describes at least a part of the road 20 on which the motor vehicle 1 is traveling. The sensor information 11 is provided in a method step S2. For this purpose, it is provided for example to the control device 9 of the motor vehicle 1 or by means of the control device 9. The following method steps S3 to S10 are preferably also carried out by means of the control device 9 of the motor vehicle 1.

A hard shoulder detection criterion 12 is applied to the provided sensor information 11 in a method step S3, with hard shoulder information 13 being determined. This information describes whether the road 20 on which the motor vehicle 1 is traveling has a hard shoulder 22. The hard shoulder detection criterion 12 can take into account a color and/or a line type of the road marking 23 of the road 20. Alternatively or additionally, it may take into account a surface finish of the road 20. Alternatively or additionally, the hard shoulder detection criterion 12 may comprise, i.e. be based on, road edge detection methods.

It is then verified in a method step S4 whether the road 20 has the hard shoulder 22 according to the hard shoulder information 13. If this is the case, a method step S5 takes place. If this is not the case, i.e. if no hard shoulder 22 is detected, method step S1 can be repeated, for example.

If the hard shoulder information 13 divulges that the road 20 has the hard shoulder 22, traffic sign information 15 is determined in method step S5. This is done by applying a traffic sign detection criterion 14 to the provided sensor information 11. The traffic sign information 15 describes the traffic sign 25, which divulges that the hard shoulder 22 is at least temporarily permitted as a traffic lane 21 or that traveling on the hard shoulder 22 is forbidden. If the road 20 has the hard shoulder 22 for the direction of travel 26 on each of the two sides of, for example, at least one traffic lane 21, the traffic sign information 15 can be determined for both and thus for all hard shoulders 22 and verified as described below.

In a method step S6, it is verified whether the hard shoulder 22 is permitted as a traffic lane 21 according to the determined traffic sign information 15. If this is the case, a notification message 16 is provided in a method step S7. Said message at least divulges that driving on the hard shoulder 22 is permitted.

Alternatively or additionally, if it is established that the hard shoulder 22 is not permitted as a traffic lane 21 according to the determined traffic sign information 15, i.e. that traveling on the hard shoulder 22 is forbidden, a warning message 19 is provided in a method step S10. The warning message 19 at least divulges that traveling on the hard shoulder 22 is forbidden.

By means of the notification message 16 or the warning message 19, a driver of the motor vehicle 1 can be informed that driving on the hard shoulder 22 is permitted or forbidden. It is preferably provided here that the provided notification message 16 and/or warning message 19 is output by means of the audible and/or visual output device 10 of the motor vehicle 1 and/or the mobile terminal in the motor vehicle 1.

In a method step S8, if the road 20 has the hard shoulder 22 according to the hard shoulder information 13, traffic lane information 18 can be determined. For this purpose, for example, a traffic lane detection criterion 17 can be applied to the sensor information 11. The traffic lane information 18 describes the traffic lane 21 in which the motor vehicle 1 is traveling. Without method steps S5 to S7 and S10 taking place, method step S8 can take place directly after method step S4.

In a method step S9, it can be verified whether the traffic lane 21 corresponds to the hard shoulder 22 of the road 20 according to the traffic lane information 18. Only if this is not the case is method step S7 carried out, i.e. the notification message 16 is provided.

However, it can be provided that if it is established in method step S9 that the traffic lane 21 corresponds to the hard shoulder 22 of the road 20 according to the traffic lane information 18, the warning message 19 is provided in method step S10 independently of the traffic sign information 15, i.e. without the latter having to be determined at all. Alternatively, it can be provided that the warning message 19 is provided in method step S10 only if, according to the determined traffic sign information 15, traveling on the hard shoulder 22 is forbidden and also, according to the traffic lane information 18, the traffic lane 21 corresponds to the hard shoulder 22 of the road 20. In this case, all method steps S1 to S6 and S8 to S10 are carried out in this order.

It can also be provided that if the motor vehicle 1 is currently changing traffic lanes to the hard shoulder 22 according to the traffic lane information 18, the warning message 19 is provided only when the motor vehicle 1 is traveling completely on the hard shoulder 22. Prior to this, for example, time can be provided for a lane departure warning system or another driver assistance system to respond to the change of traffic lane.

It can also be provided that the traffic lane information 18 is only determined and verified if the hard shoulder 22 is permitted as a traffic lane 21 according to the determined traffic sign information 15. As soon as it is established that, according to the traffic lane information 18, the traffic lane 21 corresponds to the hard shoulder 22 of the road 20, i.e. if it is established that traveling on the hard shoulder 22 is permitted and it is also established that the motor vehicle 1 is already located on the hard shoulder 22, the traffic sign information 15 is continuously determined and verified again. Method steps S5′ and S6′ are therefore carried out. In method step S5′, the traffic sign information 15 is determined again in the same way as in method step S5, such that newly determined traffic sign information 15′ is provided. In method step S6′, the newly determined traffic sign information 15′ is verified, and if traveling on the hard shoulder 22 is forbidden according to the newly determined traffic sign information 15′, the warning message 19 is provided in method step S10. Thus, traveling on the hard shoulder 22 is tolerated without a corresponding warning message 19 only for as long as the traffic sign information 15, 15′ divulges that driving on the hard shoulder 22 is permitted. As soon as this permission is no longer present, for example because a correspondingly different traffic sign 25 has been detected, method step S10 is carried out again.

It can be provided that the notification message 16 and/or warning message 19 is output in the motor vehicle 1 by means of the audible and/or visual output device 10 only when the motor vehicle 1 has passed the traffic sign 25.

Overall, the examples show detection and warning of a hard shoulder 22. Based on lane and road edge detection, the motor vehicle 1 classifies the rightmost (or leftmost) traffic lane 21 between the rightmost (or leftmost) traffic lane line and the road edge as a hard shoulder 22 in right-hand (or left-hand) driving countries/regions. The hard shoulder line usually differs from other lane lines (for example in type and/or color) which can be easily detected by the lane detection system. For roads 20 with hard shoulders 22 on both sides of each direction of travel 26, both hard shoulders 22 are classified.

If the driver drives onto the hard shoulder 22, the motor vehicle 1 outputs a visual/audible warning to the driver. (Note: If the driver unintentionally crosses the lane line of the hard shoulder 22, the lane departure warning system of the motor vehicle 1 should be activated before the warning about the hard shoulder 22).

If the motor vehicle 1 detects the traffic sign 25 “Breakdown lane allowed” and the conditions for changing to the hard shoulder 22 are met, the motor vehicle 1 outputs a visual/audible reminder (notification message 16) to the driver. In the case of the traffic sign 25 “Travel on breakdown lane allowed”, the breakdown lane warning (warning message 19) is suppressed. If the motor vehicle 1 detects the traffic sign 25 “Travel on breakdown lane not allowed”, the breakdown lane warning (warning message 19) is no longer suppressed.

1. A method for providing information for a motor vehicle about whether driving on a hard shoulder is permitted and/or forbidden, comprising:
providing sensor information that describes an environment of the motor vehicle;
determining hard shoulder information describing whether a road on which the motor vehicle is traveling has a hard shoulder by applying a hard shoulder detection criterion to the provided sensor information;
when, according to the hard shoulder information, the road has the hard shoulder, determining traffic sign information describing a traffic sign which divulges that the hard shoulder is at least temporarily permitted as a traffic lane, or that traveling on the hard shoulder is forbidden, by applying a traffic sign detection criterion to the provided sensor information; and
verifying whether the hard shoulder is permitted as a traffic lane according to the determined traffic sign information, wherein when this is the case, a notification message is provided which at least divulges that driving on the hard shoulder is permitted, and/or when this is not the case, a warning message is provided which at least divulges that traveling on the hard shoulder is forbidden.

2. The method as claimed in claim 1, wherein when the road has the hard shoulder according to the hard shoulder information, traffic lane information is determined which describes a traffic lane of the road on which the motor vehicle is traveling and it is verified whether the traffic lane corresponds to the hard shoulder of the road according to the determined traffic lane information, wherein when this is not the case the notification message is provided.

3. The method as claimed in claim 1, wherein when the road has the hard shoulder according to the hard shoulder information, traffic lane information is determined which describes a traffic lane of the road on which the motor vehicle is traveling and it is verified whether the traffic lane corresponds to the hard shoulder of the road according to the traffic lane information, wherein when this is the case, the warning message is provided independently of the traffic sign information.

4. The method as claimed in claim 1, wherein the provided warning message is provided in the motor vehicle when, according to the determined traffic sign information, traveling on the hard shoulder is forbidden and also, according to the determined traffic lane information, the traffic lane corresponds to the hard shoulder of the road.

5. The method as claimed in claim 3, wherein when the motor vehicle is currently changing lanes to the hard shoulder according to the traffic lane information, the warning message is provided only when the motor vehicle is traveling completely on the hard shoulder.

6. The method as claimed in claim 2, wherein the traffic lane information is determined and verified when, according to the determined traffic sign information, the hard shoulder is permitted as a traffic lane, wherein when it is established that, according to the traffic lane information, the traffic lane corresponds to the hard shoulder of the road, the traffic sign information is continuously determined and verified again, wherein when it is established that, according to the newly determined traffic sign information, traveling on the hard shoulder is forbidden, the warning message is provided.

7. The method as claimed in claim 1, wherein the hard shoulder detection criterion takes into account a color and/or a line type of a road marking of the road and/or a surface finish of the road and/or comprises road edge detection methods.

8. The method as claimed in claim 1, wherein it is verified whether the road has a hard shoulder for one direction of travel on each of the two sides of at least one traffic lane, wherein when this is the case, the traffic sign information is determined and verified for each of the two hard shoulders.

9. The method as claimed in claim 1, wherein the provided notification message and/or warning message is output in the motor vehicle by means of an audible and/or visual output device.

10. The method as claimed in claim 9, wherein the output is provided only once the motor vehicle has driven past the traffic sign which divulges that the hard shoulder is at least temporarily permitted as a traffic lane or that traveling on the hard shoulder is forbidden.

11. The method as claimed in claim 1, wherein the provided sensor information is recorded by a camera device of the motor vehicle.

12. The method as claimed in claim 1, wherein, when applying the traffic sign detection criterion, at least one variable traffic sign assigned to the road is taken into account as a traffic sign.

13. A motor vehicle which is configured to carry out a method as claimed in claim 1.

14. A control device for a motor vehicle, which is configured to carry out the steps, provided for the control device, of a method as claimed in claim 1.

15. A non-transisotyr computer readable medium comprising instructions which, when the program is executed by a computer, cause the computer to perform a method as claimed in claim 1.
